(19) United States
(12) Patent Application Publication
(10) Pub. No.: US 2026/0112029 A1
(43) Pub. Date: Apr. 23, 2026

(54) Methods and Systems for Categorizing and Evaluating Cells in Images Captured by Diagnostic Instrumentation

(71) Applicant: IDEXX Laboratories, Inc., Westbrook, ME (US)

(72) Inventor: Jacob Kesinger, Westbrook, ME (US)

(21) Appl. No.: 19/362,241

(22) Filed: Oct. 17, 2025

Related U.S. Application Data
(60) Provisional application No. 63/709,700, filed on Oct. 21, 2024.

(51) Int. Cl. G06T 7/00; G06T 7/12; G06T 7/136; G06T 7/62; G06T 7/64; G06V 10/26; G06V 10/764; G06V 20/69

(52) U.S. Cl. CPC G06T 7/0012; G06T 7/12; G06T 7/136; G06T 7/62; G06T 7/64; G06V 10/267; G06V 10/764; G06V 20/695; G06V 20/698; G06T 2207/10056; G06T 2207/20081; G06T 2207/20084; G06T 2207/30024; G06T 2207/30242; G06V 2201/03

(57) ABSTRACT

An example method for characterizing and evaluating cells within images includes identifying, using machine-learning logic executed on a processor that is trained using cell image training data including digital microscopy images labeled with cell features, one or more cells in an image from a digital microscopy system, dividing an area of the image including the one or more cells into distinct regions to generate measurements of pixel value changes between the distinct regions, determining a presence and a location of RNA within the one or more cells in the image based on the measurements of pixel value changes, and categorizing, using the machine-learning logic executed on the processor, the one or more cells in the image when the presence and the location of the RNA is determined within the image of the one or more cells.

### CROSS-REFERENCE TO RELATED APPLICATION

The present disclosure claims priority to U.S. application No. 63/709,700 filed on Oct. 21, 2024, the entire contents of which are herein incorporated by reference.

### FIELD

The present disclosure relates generally to methods and systems for characterizing and evaluating cells from a physical sample of a patient, and more particularly, to using machine-learning image-based data processing of an image of the cells.

### BACKGROUND

Automated microscopy techniques produce images of many cells. Image recognition machine-learning methods have been developed to characterize cells and samples. However, outputs of the machine-learning methods are often generic and lack details of underlying rationale. While machine-learning methods can distinguish between types of cells, it is desirable to provide more objective information to support the conclusions derived from machine-learning algorithms.

### SUMMARY

Examples methods and systems herein relate to using machine-learning image based data processing of an image of cells from a sample of a patient to evaluate a radial distribution of components of the cell, to evaluate a sector distribution of components of the cell, to evaluate presence or absence of components of the cell, and to determine morphology of components of the cell in order to provide interpretable context about the cell image as relates to an output of the machine-learning data processing.

In one example, a method for characterizing cells is described comprising identifying, using machine-learning logic executed on a processor, one or more cells in an image from a digital microscopy system. The machine-learning logic is trained using cell image training data including digital microscopy images labeled with cell features. The method also comprises dividing an area of the image including the one or more cells into distinct regions to generate measurements of pixel value changes between the distinct regions, determining a presence and a location of RNA within the one or more cells in the image based on the measurements of pixel value changes, and categorizing, using the machine-learning logic executed on the processor, the one or more cells in the image when the presence and the location of the RNA is determined within the image of the one or more cells.

In another example, a computing device is described comprising one or more processors, and non-transitory computer readable medium having stored therein instructions that when executed by the one or more processors, causes the computing device to perform functions. The functions comprise identifying, using machine-learning logic, one or more cells in an image from a digital microscopy system. The machine-learning logic is trained using cell image training data including digital microscopy images labeled with cell features. The functions also comprise dividing an area of the image including the one or more cells into distinct regions to generate measurements of pixel value changes between the distinct regions, determining a presence and a location of RNA within the one or more cells in the image based on the measurements of pixel value changes, and categorizing, using the machine-learning logic, the one or more cells in the image when the presence and the location of the RNA is determined within the image of the one or more cells.

In another example, a non-transitory computer readable medium having stored thereon instructions, that when executed by one or more processors of a computing device, cause the computing device to perform functions. The functions comprise identifying, using machine-learning logic, one or more cells in an image from a digital microscopy system. The machine-learning logic is trained using cell image training data including digital microscopy images labeled with cell features. The functions also comprise dividing an area of the image including the one or more cells into distinct regions to generate measurements of pixel value changes between the distinct regions, determining a presence and a location of RNA within the one or more cells in the image based on the measurements of pixel value changes, and categorizing, using the machine-learning logic, the one or more cells in the image when the presence and the location of the RNA is determined within the image of the one or more cells.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The novel features believed characteristic of the illustrative examples are set forth in the appended claims. The illustrative examples, however, as well as a preferred mode of use, further objectives and descriptions thereof, will best be understood by reference to the following detailed description of an illustrative example of the present disclosure when read in conjunction with the accompanying drawings, wherein:

FIG. 1 illustrates an example of a system, according to an example implementation.

FIG. 2 illustrates an example of the computing device in FIG. 1, according to an example implementation.

FIG. 3A is an example of an image of a cell captured by the imaging system of the digital microscopy system of FIG. 1, according to an example implementation.

FIG. 3B illustrates a portion of the image of FIG. 3A divided into annular segments, according to an example implementation.

FIG. 3C illustrates another portion of the image of FIG. 3A divided into annular segments and a central region, according to an example implementation.

FIG. 4A illustrates an image of a cell in which a nucleus is present, according to an example implementation.

FIG. 4B illustrates an image of a cell in which a nucleus is not present, according to an example implementation.

FIG. 5A is another example of an image of a cell captured by the imaging system of the digital microscopy system of FIG. 1, according to an example implementation.

FIG. 5B is an example of the image of FIG. 5A divided into sector segments, according to an example implementation.

FIG. 6 illustrates an example of a conceptual nucleus of a cell from an image output by the imaging system of the digital microscopy system of FIG. 1, according to an example implementation.

FIG. 7 shows a flowchart of an example of a method for characterizing cells, according to an example implementation.

### DETAILED DESCRIPTION

Disclosed examples will now be described more fully hereinafter with reference to the accompanying drawings. Indeed, several different examples may be described and should not be construed as limited to the examples set forth herein. Rather, these examples are described so that this disclosure will be thorough and complete and will fully convey the scope of the disclosure to those skilled in the art.

Within examples described herein, technical solutions are provided to assist with generating interpretive context data to support outputs of a machine-learning based classification algorithm used to classify cells in images output from a digital microscopy system. Some image recognition machine-learning methods have been developed to characterize cells and samples. However, outputs of the machine-learning methods are often generic and lack details of underlying rationale. Examples systems and methods described herein process received images in a technical manner to output supporting data for the classification output.

In one example, from a diagnostic standpoint, identifying a radial distribution of RNA in cytoplasm of a cell is desirable to aid in distinguishing cell types, and systems and methods described herein execute further image processing algorithms to evaluate cell features in an image to determine RNA distribution by annuli portions of the image. The RNA distribution is an indicator of a cell type and output as interpretive context with a classification of the cell made by the machine-learning algorithm.

In another example, from a diagnostic standpoint, identifying if a cell or other object is nucleated or anucleate is desirable to aid in distinguishing cell types, and systems and methods described herein execute further image processing algorithms to evaluate a presence or absence of one or more nuclei in a cell of an image. For example, if no nucleus is present in the image of the cell, there is no RNA to analyze, in which case the computing device 110 is configured to switch machine-learning logic for further image processing on cells that do not include a nucleus.

In another example, from a diagnostic standpoint, identifying if cells have clumped chromatin and whether chromatin is distributed throughout the nucleus is desirable to aid in distinguishing cell types, and systems and methods described herein execute further image processing algorithms to determine a distribution of chromatin in the nucleus of a cell. As captured by an image, chromatin concentration appears as a pixel intensity where brighter pixels correspond to denser chromatin, and such information is output as interpretive context with a classification of the cell made by the machine-learning algorithm.

In another example, from a diagnostic standpoint, characterizing a shape of a nucleus is desirable to aid in distinguishing cell types, and systems and methods described herein execute further image processing algorithms to determine a morphology of a cell. For example, geometric properties of the contour and other cell features of the nucleus are output as interpretive context with a classification of the cell made by the machine-learning algorithm.

Implementations of this disclosure thus provide technological improvements that are particular to computer technology, for example, those concerning validation, verification, and providing assurances of classifications made by trained machine-learning algorithms. Computer-specific technological problems, such as executing machine-learning logic in beneficial ways, can be wholly or partially solved by implementations of this disclosure. For example, implementation of this disclosure allows for outputs of a machine-learning cell classification algorithm to be validated by associating any one or more numerous interpretative context data about the cell as further data indicative of a cell type. When the interpretative context data maps to the same cell type as a classification output from execution of the machine-learning algorithm, validation is complete.

The systems and methods of the present disclosure further address problems particular to computer devices and operation of digital imaging instruments, for example, those concerning analysis of captured images. Utilizing machine-learning algorithms, trained on manually labeled images, enables a more immediate and normalized analysis of the data. Thus, analysis of the diagnostic data can occur in a manner that is efficient and takes into account all patients' needs. Implementations of this disclosure introduce new and efficient improvements in the ways in which data output from digital imaging instruments is analyzed to validate classification results, for example, in an automated and unbiased manner.

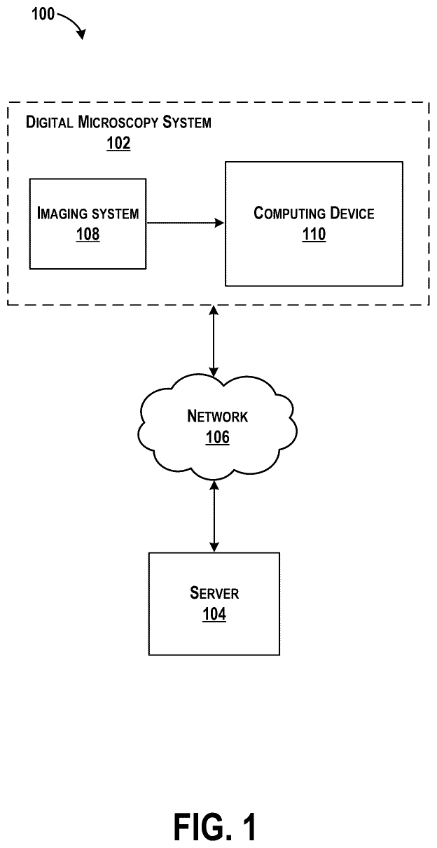

Referring now to the figures, FIG. 1 illustrates an example of a system 100, according to an example implementation. The system 100 includes a digital microscopy system 102, a server 104, and a network 106. The digital microscopy system 102 is accessible by the server 104 through the network 106.

In embodiments, the digital microscopy system 102 includes an imaging system 108 and a computing device 110. In other embodiments, the digital microscopy system 102 includes the imaging system 108 and the computing device 110 is a separate component such that the digital microscopy system 102 is in communication with the computing device 110 via a direct wired or wireless communication.

The digital microscopy system 102 is a form of a diagnostic testing instrument operable to perform diagnostic testing of samples of patients, such as veterinary patients for example. Within examples, the digital microscopy system 102 includes additional components or is a component of a larger testing instrument. Examples of forms of the digital microscopy system 102 include any one or combination of veterinary analyzers operable to conduct a diagnostic test of a sample of a patient, and can include without limitation, a clinical chemistry analyzer, a hematology analyzer, a microscopic analyzer, a urine analyzer, an immunoassay reader, a sediment analyzer, a blood analyzer, a digital radiology machine, and/or the like.

In the system 100, the network 106 (e.g., Internet) provides access to the digital microscopy system 102 and the server 104 for all network-connected components. Communication with the digital microscopy system 102 and the server 104 and/or with the network 106 may be wired or wireless communication (e.g., some components may be in wired Ethernet communication and others may use Wi-Fi communication).

In operation, the digital microscopy system 102 receives a sample of a patient for processing. In an example, the sample is on a microscope slide for analysis using clinical histopathology based on bright-field microscopy of thinly sliced tissue specimens. In another example, the digital microscopy system 102 uses slide-free histopathology with direct imaging of intact, minimally processed tissue or fluid samples using the imaging system 108, which includes optics and camera components for image processing.

The imaging system 108 captures multiple field of views of the sample into a single image. This process often requires automated image-stitching algorithms that correct field distortion, normalize intensity, align images, and merge them into a single matrix. Image contrast can be distinct in different dynamic ranges, and may be better visualized after high-dynamic-range correction. Color-remapping algorithms can also be implemented to combine and translate novel contrasts into pathologist-familiar color schemes. In examples, the imaging system 108 is capable of using one of many different imaging modalities such as bright-field microscopy, fluorescence imaging, nonlinear microscopy, and structured illumination.

The imaging system 108 outputs one or more images of the sample to the computing device 110 for analysis. In some examples, the imaging system 108 additionally or alternatively outputs one or more images of the sample to the server 104 for analysis. In still other examples, the imaging system 108 outputs one or more images of the sample to both the computing device 110 and the server 104 for analysis where each of the computing device 110 and the server 104 perform portions of the analysis. Any image analysis described herein may be performed by the computing device 110 (either internal to the digital microscopy system 102 or a component separate from the digital microscopy system 102), by the server 104, or portions may be performed by the computing device 110 and the server 104 in communication via the network 106.

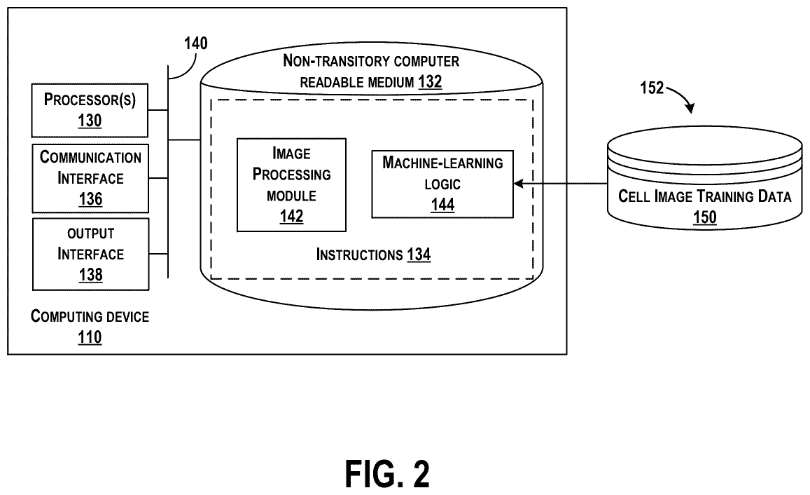

FIG. 2 illustrates an example of the computing device 110 in FIG. 1, according to an example implementation. Within examples herein, functions described for processing outputs of the imaging system 108 are performed by the computing device 110, by the server 104, or by a combination of the computing device 110 and the server 104. Thus, although FIG. 2 illustrates the computing device 110, the components of the server 104 are the same as the components of the computing device 110 within some examples, depending on where a function is programmed to be performed in a specific implementation.

The computing device 110 includes one or more processor(s) 130, and non-transitory computer readable medium 132 having stored therein instructions 134 that when executed by the one or more processor(s) 130, causes the computing device 110 to perform functions for processing an image or multiple images output from the imaging system 108 of the digital microscopy system 102, as well as management and control of functionality of the digital microscopy system 102, for example.

To perform these functions, the computing device 110 also includes a communication interface 136, an output interface 138, and each component of the computing device 110 is connected to a communication bus 140. The computing device 110 may also include hardware to enable communication within the server 104 and between the computing device 110 and other devices (not shown). The hardware may include transmitters, receivers, and antennas, for example. The computing device 110 may further include a display (not shown).

The communication interface 136 may be a wireless interface and/or one or more wireline interfaces that allow for both short-range communication and long-range communication to one or more networks or to one or more remote devices. Such wireless interfaces may provide for communication under one or more wireless communication protocols, Bluetooth, WiFi (e.g., an institute of electrical and electronic engineers (IEEE) 802.11 protocol), Long-Term Evolution (LTE), cellular communications, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. Thus, the communication interface 136 may be configured to receive input data from one or more devices, and may be configured to send output data to other devices.

The non-transitory computer readable medium 132 includes or takes the form of memory, such as one or more computer-readable storage media that can be read or accessed by the one or more processor(s) 130. The non-transitory computer readable medium 132 can include volatile and/or non-volatile storage components, such as optical, magnetic, organic or other memory or disc storage, which can be integrated in whole or in part with the one or more processor(s) 130. In some examples, the non-transitory computer readable medium 132 is implemented using a single physical device (e.g., one optical, magnetic, organic or other memory or disc storage unit), while in other examples, the non-transitory computer readable medium 132 is implemented using two or more physical devices. The non-transitory computer readable medium 132 thus is a computer readable storage, and the instructions 134 are stored thereon. The instructions 134 include computer executable code.

The one or more processor(s) 130 may be general-purpose processors or special purpose processors (e.g., digital signal processors, application specific integrated circuits, etc.). The one or more processor(s) 130 receive inputs from the communication interface 136 (e.g., x-ray images), and process the inputs to generate outputs that are stored in the non-transitory computer readable medium 132. The one or more processor(s) 130 are configured to execute the instructions 134 (e.g., computer-readable program instructions) that are stored in the non-transitory computer readable medium 132 and are executable to provide the functionality of the computing device 110 described herein.

The output interface 138 outputs information for transmission, reporting, or storage, and thus, the output interface 138 may be similar to the communication interface 136 and can be a wireless interface (e.g., transmitter) or a wired interface as well.

Within examples, the instructions 134 include specific software for performing functions including an image processing module 142, and machine-learning logic 144.

In one example operation, the processor(s) 130 execute the instructions 134 stored on the non-transitory computer readable medium 132 to cause the computing device 110 to perform functions including identifying, using the machine-learning logic 144 executed on the processor 130, one or more cells in an image from the digital microscopy system 102, dividing an area of the image including the one or more cells into distinct regions to generate measurements of pixel value changes between the distinct regions by execution of the image processing module 142, determining a presence and a location of RNA within the one or more cells in the image based on the measurements of pixel value changes, and categorizing, using the machine-learning logic 144 executed on the processor 130, the one or more cells in the image when the presence and the location of the RNA is determined within the image of the one or more cells.

The machine-learning logic 144 is trained using cell image training data 150 including digital microscopy images labeled with cell features. The training database is accessible in an associated database 152.

Execution of the machine-learning logic 144 to perform analysis of the digital microscopy images results removes any human bias and generates normalized results for all inputs.

Referring to the machine-learning logic 144, many types of functionality and neural networks can be employed to perform functions of specific machine-learning algorithms to carry out functionality described herein. In one example, the machine-learning logic 144 use statistical models to generate outputs without using explicit instructions, but instead, by relying on patterns and inferences by processing associated training data.

The machine-learning logic 144 can thus operate according to machine-learning tasks as classified into several categories. In supervised learning, the machine-learning logic 144 build a mathematical model from a set of data that contains both the inputs and the desired outputs. The set of data is sample data known as the “training data”, in order to make predictions or decisions without being explicitly programmed to perform the task. For example, the machine-learning logic 144 utilizes the cell image training data 150 within comparisons to identify matches in received image data to the labeled cell image data that are within a similarity threshold. When such a match is found, the labeled cell image data is referenced as a label to be applied to the received cell image and the label is further used for defining the data in the image for classification.

In another category referred to as semi-supervised learning, the machine-learning logic 144 develop mathematical models from incomplete training data, where a portion of the sample input does not have labels. A classification algorithm can then be used when the outputs are restricted to a limited set of values.

In another category referred to as unsupervised learning, the machine-learning logic 144 builds a mathematical model from a set of data that contains only inputs and no desired output labels. Unsupervised learning algorithms are used to find structure in related training data, such as grouping or clustering of data points. Unsupervised learning can discover patterns in data, and can group the inputs into categories.

Alternative machine-learning algorithms may be used to learn and classify types of cell images, such as deep learning though neural networks or generative models. Deep machine-learning may use neural networks to analyze prior test results through a collection of interconnected processing nodes. The connections between the nodes may be dynamically weighted. Neural networks learn relationships through repeated exposure to data and adjustment of internal weights. Neural networks may capture nonlinearity and interactions among independent variables without pre specification. Whereas traditional regression analysis requires that nonlinearities and interactions be detected and specified manually, neural networks perform the tasks automatically.

Still other machine-learning algorithms or functions can be implemented to determine and identify content in cell images, such as any number of classifiers that receives input parameters and outputs a classification (e.g., attributes of the image). Support vector machine, Bayesian network, a probabilistic boosting tree, neural network, sparse auto-encoding classifier, convolutional neural network (e.g., for image-based classifiers) or other known or later developed machine-learning algorithms may be used. Any semi-supervised, supervised, or unsupervised learning may be used. Hierarchal, cascade, or other approaches may be also used.

The machine-learning logic 144 may thus be considered an application of rules in combination with learning from prior labeled data to identify appropriate outputs. Analyzing and relying on prior labeled data allows the machine-learning logic 144 to apply patterns of cell data to received cell images for image content identifications, for example.

Thus, the machine-learning logic 144 take the form of one or a combination of any of the herein described machine-learning algorithms, for example.

As mentioned above, the imaging system 108 of the digital microscopy system 102 outputs one or more images of the sample to the computing device 110 for analysis. The analysis includes identification of many different features of cells in the images, in many different ways, as described below.

### (I) Evaluation of Cell Features in an Image by Annuli

In one example, from a diagnostic standpoint, identifying a radial distribution of RNA in cytoplasm of a cell is desirable to aid in distinguishing cell types. A distribution of RNA in extra-nuclear cytoplasm of a cell may be concentrated towards a cell boundary, avoidant of a region around a nucleus, clumped or diffuse, or absent entirely.

The imaging system 108 of the digital microscopy system 102 captures an image of a patient sample, and outputs the image to the computing device 110. Generally, as captured by the imaging system 108, RNA concentration in the image appears as a pixel intensity. For example, the more RNA that is present at a location in the cell, the brighter the pixel will be in the image at that location. Different cell types and cell features tend to have different patterns of brighter and darker areas in their cytoplasm. Thus, to determine a distribution of RNA within the cytoplasm, the distribution can be quantified according to regions of the image.

Within examples, the cytoplasm in the image is divided into annular segments in order to divide the image of the one or more cells into a plurality of annuli where a presence and location of the RNA are determined within the plurality of annuli. This results in a transformation of the image into annular segments or rings, and image processing is executed on sets of annular segments.

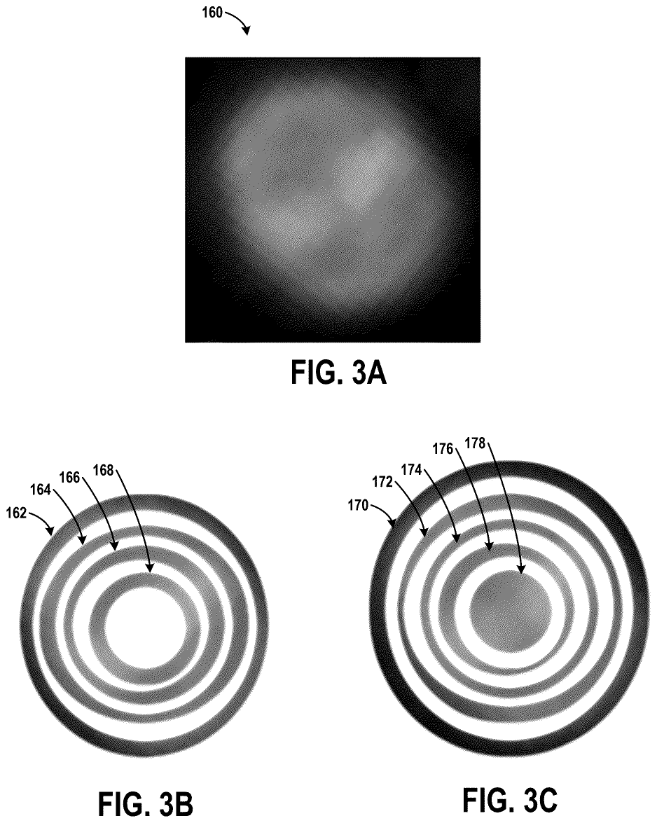

FIG. 3A is an example of an image 160 of a cell captured by the imaging system 108 of the digital microscopy system 102 of FIG. 1, according to an example implementation. The image 160 is a false color image of the cell that can be provided in a bluish color, where an outermost portion of the cell is a different color (e.g., more green) than an inner portion, and thus, the color is less blue in the outer portion than the inner portion. With this color scheme, a blue color corresponds to RNA, and thus, in the example shown in FIG. 3A, there is more RNA present in a central region of the cell than an outer region.

To quantify a distribution of RNA, the image is divided in annular segments as shown in FIGS. 3B and 3C, for example.

FIG. 3B illustrates a portion of the image 160 of FIG. 3A divided into annular segments 162, 164, 166, and 168, according to an example implementation. FIG. 3C illustrates another portion of the image 160 of FIG. 3A divided into annular segments 170, 172, 174, and 176, and a central region 178, according to an example implementation. A combination of the annular segments in FIG. 3B and FIG. 3C form the entirety of the image 160. Thus, the annular segments in FIG. 3B and FIG. 3C are concentric circles (more or less circular in shape), where alternating annular segments are grouped together in the grouping of FIG. 3B and remaining alternating annular segments are grouped together in the grouping of FIG. 3C. Dividing the image 160 into a set of annular segments 162, 164, 166, and 168 creates a modified representation of the image 160. Similarly, dividing the image 160 into another set of the annular segments 170, 172, 174, 176, and the central region 178 creates yet another modified representation of the image 160.

A comparison of the annular segments in FIG. 3B and FIG. 3C (e.g., of each of the modified representations of the image 160) shows a different distribution of pixel intensities. The segment 170 (e.g., outer ring in FIG. 3C), has a darker pixel intensity than the segment 162 (e.g., outer ring in FIG. 3B). A darker pixel intensity represents less RNA. Thus, in the image 160 of the cell, less RNA is present toward an edge of the cell as compared toward the center region 178 of the cell.

A distribution of RNA in cells differ, and based on the distribution, an identity, a type, or a characterization of the cells can be determined. An example of a cell type includes a maturity or age of the cell. Another example of cell type includes a type of a blood cell, and each type of blood cell has different sub-types (e.g., such as age).

As a result, the computing device 110 determines a number, distribution, or quantity value of RNA in an outermost annulus of the plurality of annuli and determines a number of RNA in an innermost annulus of the plurality of annuli, and based on the number of RNA in the outermost annulus of the plurality of annuli and the number of RNA in the innermost annulus of the plurality of annuli, identifies a cell type.

The quantity value of RNA in the annular segments is determined according to pixel values. In one example, an average pixel value per annular segment is determined. In another example, a change in pixel values between annular segments is determined for a distribution measurement of RNA (e.g., a change between alternating annular segments grouped together in the grouping of FIG. 3B or in the grouping of FIG. 3C). The change represents a slope of brightness values in pixels. The change in pixels values is used to determine a radial distribution of RNA within the image 160 of the one or more cells.

In other examples, a distribution of RNA is determined by grouping each pixel in a bucket depending on a distance from a border of the cell, and statistics on each bucket are calculated and summarized. Example statistics include pixel intensity per location from border.

An example image processing is described below. Initially, the image 160 is received, a first binary mask is received indicating which pixels in the image 160 include any portion of the cell (e.g., cell mask (A)), and a second binary mask is received indicating which pixels in the image 160 are located in its nucleus or nuclei (e.g., nuclear mask (B)). The computing device 110 execute the machine-learning logic 144 to process the image 160 and output the first and second binary masks. The computing device 110 repeatedly applies a morphological dilation operator to contents of the image 160 included in the second binary mask for the nucleus. At each step, a new mask is created including pixels that are in the first binary mask and not present in any previous step. A new mask is referred to as a “coat”. The image processing thus includes:

```
START
  Cell mask (A)
  Nuclear mask (B)
REPEAT UNTIL STOP:
  Dilate (B) into (B1) using a 3x3 square kernel;
  Compute (C) = (B1) & (A) & (~B), where ‘&’ is
  boolean AND, and ‘~’ is boolean
NOT;
  Save (C);
  Replace (B) by (B1);
  STOP WHEN (C) is empty.
```

For each coat, which may be considered one of the annular segments, the following values are determined including a mean pixel intensity (e.g., coat mean), a difference between maximum and minimum pixel intensities (e.g., a coat range), and an entropy of the distribution of pixel intensities (e.g., a coat entropy). Then, for the cell, the values shown below in Table 1 are computed and reported.

TABLE 1
Variance of coat means
Minimum coat mean
Maximum coat mean
Variation of coat entropy
Median of coat means
The slope (m) of the linear fit ‘y_i = mi + b’ where ‘y_i’ is the ith coat
range
The slope (m) of the linear fit ‘y_i = mi + b’ where ‘y_i’ is the ith coat
entropy
The difference between the first coat mean and the mean of the remaining
coat means
The difference between the last coat mean and the mean of the remaining
coat means
Whether the darkest coat is the innermost.
Whether the brightest coat is the outermost.

Values shown in Table 1 relate to pixel intensity values of the annular segments. Analysis of the values maps to a presence or absence of RNA at a location in the image 160 of the cell, and a distribution of RNA throughout the cell. Using the example image processing method herein provides an automated and programmatic solution for evaluation of images of cells on a basis of RNA presence and distribution, in contrast to a manual slide evaluation performed by pathologists that is prone to inconsistencies and variations in judgement. For example, after determining the presence and the location of RNA within the one or more cells in the image based on the measurements of pixel value changes, the computing device 110 categorizes, using the machine-learning logic 144 executed on the processor 130, the one or more cells in the image when the presence and the location of the RNA is determined within the image of the one or more cells. The categorization is based on the machine-learning logic 144 being trained on prior categorized cells. The categorization output by the machine-learning logic 144 can be verified or validated using different combinations of the values shown in Table 1, as well as different values within combinations, that are also mapped to categorizations, for example. When the categorization output by the machine-learning logic 144 and the categorization to which values shown in Table 1 match, a validation occurs.

In addition, the example image processing method provides interpretable context including multiple pixel value measurements and comparisons as a basis for a cell classification. The contents improves customer and pathologist confidence in reported image processing results. The distribution of RNA, for example, reveals sub-populations of diagnostic interest that are not easily discernable by a human.

### (II) Classification of a Cell as Nucleated or Anucleate

In another example, from a diagnostic standpoint, identifying if a cell or other object is nucleated or anucleate is desirable. Certain types of cells, most commonly erythrocytes, lack a nucleus as do non-cellular objects, such as cholesterol crystals. Identifying a presence or absence of one or more nuclei can be a useful first step for other cellular evaluations. For example, if no nucleus is present in the image of the cell, there is no RNA to analyze, in which case the computing device 110 is configured to switch machine-learning logic for further image processing on cells that do not include a nucleus.

To determine if a nucleus is present in the image of the cell, a series of decision rules are executed by the computing device 110 based on intensities in portions of the received image from the imaging system 108 of the digital microscopy system 102.

In one example, the imaging system 108 of the digital microscopy system 102 outputs three grayscale images capturing a fluorescent intensity of a stain that binds to DNA of a sample and a fourth grayscale image capturing a fluorescent intensity of a stain that binds to RNA. A brightness of pixels in these images is proportional to an amount of stain that is present at that location, which in turn, is proportional to an amount of the associated nucleic acid at that location.

An intensity normalization process, calibrated from a larger image, is executed by the computing device 110 and applied to minimize effects of instrument manufacturing variations, reagent formulation variations, and sample preparation variations, for example.

Following, the computing device 110 calculates various statistics on pixel intensities in the image as a basis for determining presence or absence of a nucleus in the cell. The intensity of a pixel at a location is proportional to the concentration of a fluorescent dye, hence DNA or RNA, at a location. Under normal conditions, DNA is only found in the nucleus, and RNA is preferentially found in the nucleus, so a nucleated cell will have a different distribution of pixel intensities than an anucleated cell.

In one example, a series of decision rules is applied where each of the decision rules is related to pixel values, background/foreground thresholds, and the like. A rule at each step may make a decision, and the process stops, or may yield to the rule at the next step. After all rules are applied, the computing device 110 outputs a decision of whether the cell contains a nucleus or not.

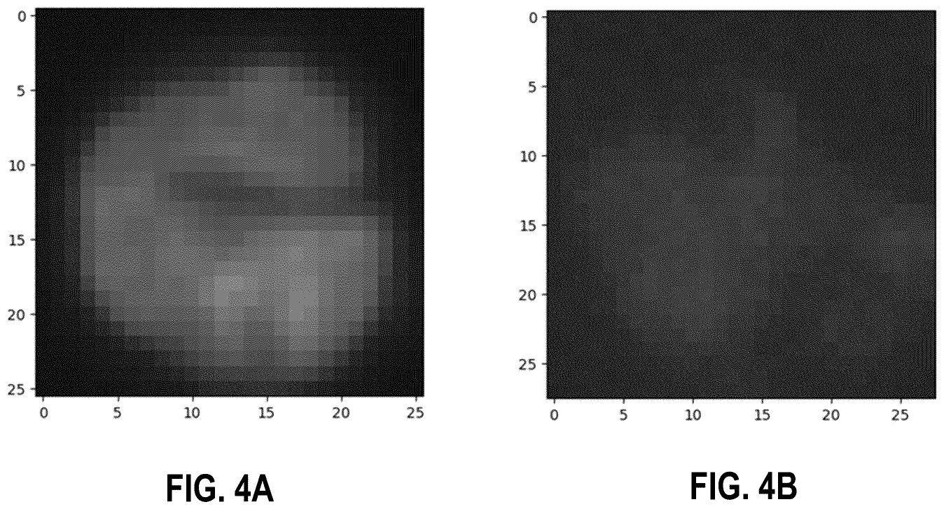

FIG. 4A illustrates an image of a cell in which a nucleus is present, according to an example implementation. FIG. 4B illustrates an image of a cell in which a nucleus is not present, according to an example implementation. As seen by comparison of the images in FIGS. 4A and 4B, when a nucleus is present, pixel intensity is greater due to fluorescence of the nucleus. When the nucleus is not present, the pixel intensity is lower.

In examples, the normalized images of the DNA-bound stain are denoted as [Da], [Db], and [Dc], the un-normalized image is denoted as [Dc] as [Uc], and that of the RNA-bound stain is denoted as [R]. For each of [Da], [Db], [Dc], and [R] Otsu thresholding is applied, or example image processing to separate foreground and background pixels in the image. The thresholds [Tc] and [TR] that separate foreground from background in the [Dc] and [R] channels are saved, as well as binary images [Ma], [Mb], and [Mc] indicating whether a pixel is foreground or background for the channels [Da], [Db], and [Dc]. Following, the computing device 110 writes [Ic] for a cropped version of [Dc] that shares a same center as [Dc] but whose horizontal and vertical extents are half those of [Dc]. The computing device 110 writes [Qc] for a difference between an intensity of a pixel brighter than about 99% (+/−5%) of other pixels in [Dc] and an intensity of a pixel brighter than just about 1% (+/−0.5%) of the other pixels in [Dc].

Integer-valued images [M], [Dx], and binary image [J] are defined as follows:

$$[ M ] = 4 * [ Ma ] + 2 * [ Mb ] + [ Mc ]$$

$$[ J ] = [ Ma ] * [ Mb ] * [ Mc ]$$

$$[ Dx ] = ( [ J ] * [ Dc ] - [ J ] * [ Da ] )$$

Here multiplication and addition are defined pixel-wise, and signed arithmetic is used in the calculation of [Dx]. Let [C0] be the number of values in [M] that are 2, 4, 5, or 6, and [C1] be the number of values in [M] that are 0, 1, 3, or 7. The computing device 110 executes a series of yes/no questions, in the order shown in Table 2 below.

TABLE 2

| | |
|---|---|
| 1. | Are there fewer than 10 distinct values in [Dc]? |
| | If YES, the cell is anucleate. |
| | If NO: |
| 2. | Is the difference between the maximum and minimum |
| | intensities in [Uc] less than 50? |
| | If YES, the cell is anucleate. |
| | If NO: |
| 3. | Is [Tc] at least 80? |
| | If YES, the cell is nucleated. |
| | If NO: |
| 4. | Is the maximum intensity in [Ic] at least 80? |
| | If YES, the cell is nucleated. |
| | If NO: |
| 5. | Is [Qc] no more than 40? |
| | If YES, the cell is anucleate. |
| | If NO: |
| 6. | Is the mean value of [Dx] less than or equal to 5? |
| | If NO, the cell is anucleate. |
| | If YES: |
| 7. | Is the mean value of [Dx] greater than or equal to 30? |
| | If YES, the cell is nucleated. |
| | If NO: |
| 8. | Is [Tr] less than 10? |
| | If NO, the cell is anucleate. |
| | If YES: |
| 9. | Is ([C0] − [C1])/([C0] + [C1]) less than or equal to −0.5? |
| | If YES, the cell is nucleated. |
| | If NO: |
| 10. | The cell is anucleate. |

Using the example image processing method herein provides an automated and programmatic solution for evaluation of images of cells to determine presence of a nucleus. Thus, in one example, the decision rules shown in Table 2 above enable determining whether cells of the one or more cells in the image comprise a nucleus based on a threshold between a foreground of the image and a background of the image exceeding a configurable difference. In another example, the decision rules shown in Table 2 above enable determining whether cells of the one or more cells in the image comprise a nucleus based on intensity of the pixel values in the image being proportional to a concentration of a fluorescent dye at a location of the pixel values, which is proportional to an amount of DNA at the location.

Many computations of interest are only applicable to either nucleated or anucleate cells but not both, and the example image processing method reduces computational load and hence time-to-result accordingly.

In addition, within examples, the image processing method provides a justification for why a cell categorized as nucleated or anucleate (instead of merely a yes-no answer output of the machine-learning logic 144), which will improve customer and pathologist confidence in reported results. Other image processing of the digital microscopy system 102 are only meaningful for either nucleated or anucleate cells, but not both, and an early classification will reduce needless effort and improve time-to-results.

### (III) Evaluation of Cell Features in an Image by Sector

In another example, from a diagnostic standpoint, identifying if cells have clumped chromatin and whether chromatin is distributed throughout the nucleus is desirable to aid in distinguishing cell types. A distribution of chromatin in the nucleus of a cell may be concentrated to a few locations or broadly dispersed throughout the nucleus. As captured by an image, chromatin concentration appears as a pixel intensity where brighter pixels correspond to denser chromatin. Different cell types tend to have different patterns of brighter and darker areas in their nuclei leading to a difference in distribution of chromatin.

In one example, the imaging system 108 of the digital microscopy system 102 outputs an image of a cell, and the computing device 110 executes the image processing methods above to determine the image of the cell includes a nucleus. Given the image of a nucleated cell (or the image of the cell and a binary mask indicating which pixels include a nucleus or nuclei), the computing device 110 executes an image processing method to divide pixels in the nuclear region into multiple (e.g., eight) equiangular sectors. A mean, variance, and entropy of the pixel intensities in each sector are calculated, and then those statistics are summarized to determine a distribution of chromatin in the nucleus. In addition to direct pathologist interpretation, these statistics are further incorporated into the machine-learning model.

Thus, to determine if chromatin is clumped, a distribution of chromatin within the nucleus is identified, and to do so, the computing device 110 executes the image processing methods to divide the nucleus into sector segments.

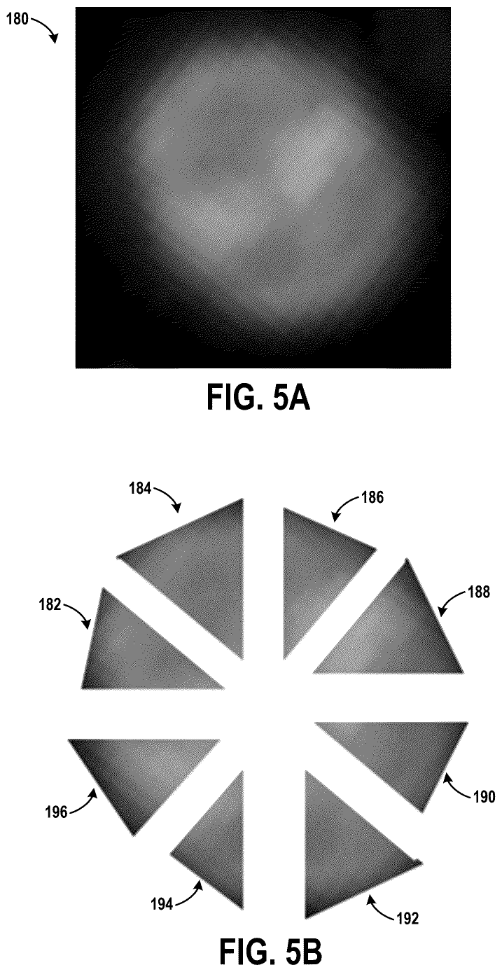

FIG. 5A is another example of an image 180 of a cell captured by the imaging system 108 of the digital microscopy system 102 of FIG. 1, according to an example implementation. The image 180 is a false color image of the cell that can be provided in a bluish color. With this color scheme, a blue color corresponds to RNA.

FIG. 5B is an example of the image 180 of FIG. 5A divided into sector segments 182, 184, 186, 188, 190, 192, 194, and 196, according to an example implementation. The sector segments 182-196 are adjacent geometrically distinct regions of the image 180 of the one or more cells. Division of the image 180 into the sector segments 182-196 results in a transformation of the image 180 into an alternate representation. Following, image processing methods are executed on respective ones of the sector segments 182-196 to localize detection of cells features to a specific area or specific pixels in the image 180.

In one example, the computing device 110 executes image processing methods to determine a largest detected nucleus in the image of the cell, and a pixel corresponding to its approximate center is calculated. Coordinates of this pixel are designated (xc, yc). Then, for every other pixel in the nucleus, whose coordinates are written (x, y), an angle THETA is computed as follows: THETA=arctan 2(y−yc, x−xc).

Each pixel is categorized according to int(THETA*8/(2*pi)). A set of pixels with a given value is referred to as a “sector”. For each sector, and every channel, the following values are calculated: mean pixel intensity (“sector mean”), difference between maximum and minimum pixel intensities (“sector range”), and entropy of the distribution of pixel intensities (“sector entropy”). Then, the computing device 110 calculates the following values for the image of the cell including (i) variance of sector means, (ii) variance of sector entropies, (iii) maximum sector range, (iv) minimum sector range, and (v) number of sectors with at least one pixel, for example. Each channel or sector will have this quintet of values, and it is the combined values over all eight or more sectors that will be used. The values are used as input into a follow-on machine-learning model for full classification, in some example.

In one example use, different intensity values of different sectors indicate a number of chromatin in the adjacent geometrically distinct regions, or a density of chromatin in the adjacent geometrically distinct regions. Based on a detected distribution of chromatin, determinations of cell types can be made. Thus, within examples, the image processing method provides a justification for why cells are categorized accordingly by the machine-learning logic, so that outputs of the machine-learning logic 144 can be compared to corresponding cell type outputs based on detected distribution of chromatin for validation. Such validation will improve customer and pathologist confidence in reported results. Chromatin distribution can also reveal subpopulations of diagnostic interest that are not easily separated by a human.

### (IV) Evaluation of Cell Features in an Image by Morphology

In another example, from a diagnostic standpoint, characterizing a shape of a nucleus is desirable to aid in distinguishing cell types. For instance, depending on the type of cell, a nucleus may be round, elliptical, lobed, serpentine, irregular, some other shape, or entirely absent.

In one example, the imaging system 108 of the digital microscopy system 102 outputs an image of a cell, and the computing device 110 executes the image processing methods above to determine the image of the cell includes a nucleus. Given the image of a nucleated cell, the computing device 110 executes an automatic threshold process to segment the nucleus from a background in the image, and a contour that selects a nuclear envelope is calculated. Geometric properties of the contour are further calculated, as are properties of approximations to the contour such as convex hull and best-approximating ellipse. Such cell features of the nucleus are used by the computing device 110 as a basis to categorize a type of the cell.

For example, to determine a shape of a nucleus, aspects of the image are quantified to consider geometric properties of an outline of the nuclear envelope. Given the image of the nucleated cell (or the image of the cell as well as a binary image indicating which pixels are located in its nucleus or nuclei), contours are detected using border algorithms or contour tracing for topological analysis of digitized binary images.

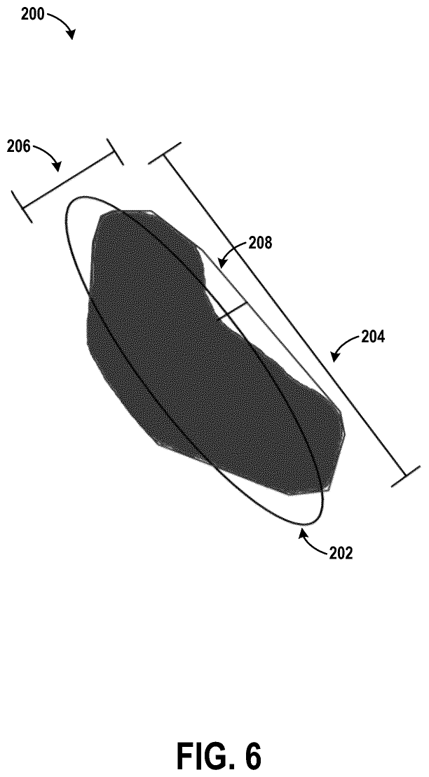

FIG. 6 illustrates an example of a conceptual nucleus 200 of a cell from an image output by the imaging system 108 of the digital microscopy system 102 of FIG. 1, according to an example implementation. The nucleus 200 has a best-fit ellipse 202 approximating a general shape (e.g., determined by a radius of a circle enclosing and contacting the contour of the nucleus), a major axis 204 (long diagonal), and minor axis 206 (small diagonal). The nucleus 200 has a convex portion that can be determined by a line normal to an estimated perimeter 208. The nucleus thus has an enclosing area inside the perimeter 208

The computing device 110 identifies a largest calculated contour, and the following values are calculated on the largest contour including an enclosing area, the perimeter, an extent (measures as the furthest L2 distance between any two points in the contour), a non-circularity (the square of the perimeter divided by 4*pi*enclosing area), whether the contour is convex or otherwise, and a radius of the smallest circle enclosing the contour.

Additional values of the morphology of the nucleus are determined by the computing device 110 by determining by [Dc] the channel in the image corresponding to a longest exposure time of a capture of the intensity of a stain binding to DNA, after a normalization process has been applied, and the following values are calculated on those pixels in [Dc] that are enclosed by the contour: image inertia (Hu Moment I1), mean pixel intensity, and entropy of the distribution of pixel intensities.

Still additional values of the morphology of the nucleus are determined by the computing device 110 by calculating details on the convex hull of the contour including the values shown below in Table 3.

TABLE 3
Enclosing area
Perimeter
Extent
Enclosing area of the original contour divided by the enclosing area of
the convex hull
Number of vertices in the original contour that are not vertices of the
convex hull
Mean distance between those vertices and the convex hull
Total distance between those vertices and the convex hull
Maximum distance between those vertices and the convex hull

The computing device 110 calculates the following values on the ellipse that best approximates the contour (e.g., in the least-squares sense): orientation of major axis, length of major axis, length of minor axis, and eccentricity.

The computing device 110 calculates the following values on a smallest rectangle enclosing the contour: aspect ratio, length of long axis, length of short axis, orientation of long axis, and area.

The computing device 110 then executes the machine-learning logic 144 to determine a type of the cell based on different characteristics of the cell nucleus accordingly from any one or any combination of all of the morphology dimensions.

Within examples, the computing device 110 executes image processing methods described herein to provide interpretable context about what exactly makes two cells different from each other, which will improve customer and pathologist confidence in reported results. In addition, nuclear morphology can reveal subpopulations of diagnostic interest that are not easily separated by a human.

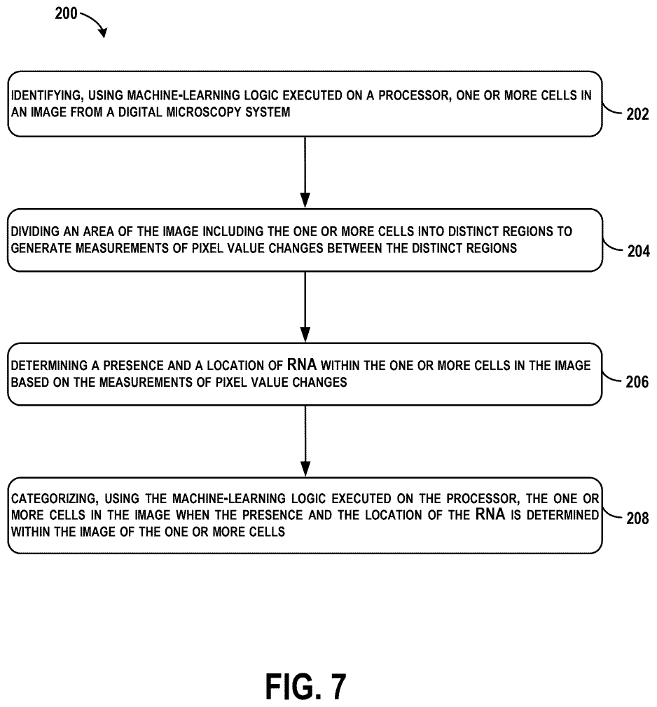

FIG. 7 shows a flowchart of an example of a method 200 for characterizing cells, according to an example implementation. Method 200 shown in FIG. 7 presents an example of a method that could be used with or implemented by the system 100 shown in FIG. 1, the computing device 110 shown in FIGS. 1-2, or the sever 104 shown in FIG. 1, for example. Further, devices or systems may be used or configured to perform logical functions presented in FIG. 7. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner. Method 200 may include one or more operations, functions, or actions as illustrated by one or more of blocks 202-208. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

It should be understood that for this and other processes and methods disclosed herein, flowcharts show functionality and operation of one possible implementation of present examples. In this regard, each block or portions of each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. Further, the program code can be encoded on a computer-readable storage media in a machine-readable format, or on other non-transitory media or articles of manufacture. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block or portions of each block in FIG. 7, and within other processes and methods disclosed herein, may represent circuitry that is wired to perform the specific logical functions in the process. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 202, the method 200 includes identifying, using machine-learning logic executed on a processor, one or more cells in an image from a digital microscopy system. The machine-learning logic is trained using cell image training data including digital microscopy images labeled with cell features.

In one example where the identifying, using the machine-learning logic executed on the processor, of the one or more cells in the image from the digital microscopy system results in determination of a presence or absence of a nucleus, the method 200 also includes using the machine-learning logic executed on the processor on grayscale images capturing fluorescent intensity of a stain that binds to DNA or RNA. In this example, an amount of pixel intensity is related to the amount of nucleic acid present.

At block 204, the method 200 includes dividing an area of the image including the one or more cells into distinct regions to generate measurements of pixel value changes between the distinct regions.

In one example, functions of block 204 includes dividing the image of the one or more cells into a plurality of annuli and determining the presence and the location of the RNA within the plurality of annuli. An example includes determining a number of RNA in an outermost annulus of the plurality of annuli and determining a number of RNA in an innermost annulus of the plurality of annuli, and based on the number of RNA in the outermost annulus of the plurality of annuli and the number of RNA in the innermost annulus of the plurality of annuli, identifying a cell type. In this instance, a distribution of RNA in the image of the cell is indicative of a specific type of the cell.

In another example, functions of block 204 include determining a radial distribution of RNA within the image of the one or more cells. For example, the functions of block 204 include dividing the image of the one or more cells into a plurality of annuli, and calculating a change in pixel intensities from an innermost annulus of the plurality of annuli and an outermost annulus of the plurality of annuli.

At block 206, the method 200 includes determining a presence and a location of RNA within the one or more cells in the image based on the measurements of pixel value changes.

At block 208, the method 200 includes categorizing, using the machine-learning logic executed on the processor, the one or more cells in the image when the presence and the location of the RNA is determined within the image of the one or more cells.

In one example, functions of block 208 include distinguishing between an age of the one or more cells.

In another example, functions of block 208 include determining whether a cell of the one or more cells in the image comprise a nucleus. For example, determining whether the cell includes a nucleus optionally includes determining that a threshold between a foreground of the image and a background of the image exceeds a configurable difference. In another example, determining whether the cell includes a nucleus optionally includes determining that pixel values of the image are indicative of a presence of DNA, and determining that the pixel values indicative of the presence of DNA exceed a configurable threshold. In another example, determining whether the cell includes a nucleus optionally includes calculating intensity of the pixel values in the image, which is proportional to a concentration of a fluorescent dye at a location of the pixel values that itself is proportional to an amount of DNA at the location. As a result, in these instances, categorizing is further performed based on the one or more cells in the image comprising the nucleus.

In still other examples, in response to determining that the cell of the one or more cells in the image comprises the nucleus, the method 200 further includes determining an area of the nucleus and dividing the area of the nucleus into adjacent geometrically distinct regions of the image of the one or more cells. In this instance, the method 200 optionally includes determining a number of chromatin in the adjacent geometrically distinct regions, and categorizing, using the machine-learning logic executed on the processor, the one or more cells in the image when the number of chromatin in the adjacent geometrically distinct regions satisfy a configurable threshold. Still further, in this instance, the method 200 optionally includes determining a density of chromatin in the adjacent geometrically distinct regions, and categorizing, using the machine-learning logic executed on the processor, the one or more cells in the image when the density of chromatin in the adjacent geometrically distinct regions satisfy a configurable threshold. In yet a further example, in this instance, the method 200 optionally includes determining a pixel intensity in the adjacent geometrically distinct regions, and categorizing, using the machine-learning logic executed on the processor, the one or more cells in the image when the pixel intensity in the adjacent geometrically distinct regions satisfy a configurable threshold.

In still other examples, functions of block 208 include determining a contour of the nucleus of the one or more cells. For example, determining the contour of the nucleus includes one or more of (i) determining one or more of an enclosing area, a perimeter, and a non-circularity of the image of the one or more cells, (ii) determining a radius of a circle enclosing and contacting the contour of the image of the one or more cells, or (iii) determining a convexity of the contour of the nucleus of the image of the one or more cells. As a result, in these instances, categorizing is further performed based on a morphology of the cells in the image such as the contour of the nucleus of the one or more cells satisfying a configurable threshold.

In some examples, functions of the method 200 are performed in combination to generate a diagnostic decision based on a number of factors. Functions performed by the computing device 110 in an example image processing method include first executing functions to determine if the cell in the image includes a nucleus, then determining a radial distribution of RNA in the cell in the image, then determining a sector distribution of RNA in the cell in the image, and then determining a morphology arrangement of the nucleus in the cell in the image. The computing device 110 categorizes the cells based on a combination of all these factors. A resulting categorization of the cells based on a combination of these factors can be used as interpretive context data to verify or validate a classification output by the machine-learning logic 144, for example. In an example where there is not a match of classifications, the computing device 110 can re-execute the machine learning logic 144 or output an error.

In some examples, the computing device 110 executes functions of the method 200 to generate a diagnostic decision based on one factor at a time. Then, where there is not a match of classifications of cell types or characteristics output from the machine-learning logic 144 (e.g., outputs young aged cell) and to that which a first factor indicates (e.g., radial distribution of RNA indicates mature aged cell), the computing device 110 then executes an additional function of the method 200 to generate a secondary diagnostic decision based on a second factor (e.g., sector distribution of RNA). Such an algorithm reduces an amount of data processing required to validate results of the machine learning logic 144. The computing device 110 continues executing functions of the method 200 to generate diagnostic decisions based on all available factors until a match of classifications of cell types or characteristics output from the machine-learning logic 144 (e.g., outputs young aged cell) and to that which a subsequent factor indicates (e.g., morphology of cell indicates young aged cell) occurs in order to validate the results.

In further examples, the machine-learning logic 144 is further trained using these different factors (labeled with diagnostic outputs) as a basis for recursive training to improve the training model accordingly.

With reference to FIG. 2, and throughout the disclosure, some components are described as “modules,” “engines”, “models”, or “generators” and such components include or take a form of a general purpose or special purpose hardware (e.g., general or special purpose processors) or firmware configured to execute described functionality, and/or software embodied in a non-transitory computer-readable (storage) medium for execution by one or more processors to perform described functionality.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

Thus, examples of the present disclosure relate to enumerated clauses (ECs) listed below in any combination or any sub-combination.
EC 1 is a method for characterizing cells, the method comprising: identifying, using machine-learning logic executed on a processor, one or more cells in an image from a digital microscopy system, wherein the machine-learning logic is trained using cell image training data including digital microscopy images labeled with cell features; dividing an area of the image including the one or more cells into distinct regions to generate measurements of pixel value changes between the distinct regions; determining a presence and a location of RNA within the one or more cells in the image based on the measurements of pixel value changes; and categorizing, using the machine-learning logic executed on the processor, the one or more cells in the image when the presence and the location of the RNA is determined within the image of the one or more cells.
EC 2 is the method of EC 1, wherein categorizing the one or more cells using the machine-learning logic comprises: distinguishing between an age of the one or more cells.
EC 3 is the method of any of ECs 1-2, wherein dividing the area of the image including the one or more cells into distinct regions comprises dividing the image of the one or more cells into a plurality of annuli and determining the presence and the location of the RNA within the plurality of annuli.
EC 4 is the method of any of ECs 1-3, further comprising: determining a number of RNA in an outermost annulus of the plurality of annuli and determining a number of RNA in an innermost annulus of the plurality of annuli; and based on the number of RNA in the outermost annulus of the plurality of annuli and the number of RNA in the innermost annulus of the plurality of annuli, identifying a cell type.
EC 5 is the method of any of ECs 1-4, wherein dividing the area of the image including the one or more cells into distinct regions comprises determining a radial distribution of RNA within the image of the one or more cells.
EC 6 is the method of any of ECs 1-5, wherein dividing the area of the image including the one or more cells into distinct regions comprises: dividing the image of the one or more cells into a plurality of annuli; and calculating a change in pixel intensities from an innermost annulus of the plurality of annuli and an outermost annulus of the plurality of annuli.
EC 7 is the method of any of ECs 1-6, wherein identifying, using the machine-learning logic executed on the processor, the one or more cells in the image from the digital microscopy system comprises using the machine-learning logic executed on the processor on grayscale images capturing fluorescent intensity of a stain that binds to DNA or RNA.
EC 8 is the method of any of ECs 1-7, further comprising normalizing an intensity of the image.
EC 9 is the method of any of ECs 1-8, further comprising determining whether a cell of the one or more cells in the image comprise a nucleus.
EC 10 is the method of any of ECs 1-9, wherein categorizing, using the machine-learning logic executed on the processor, the one or more cells in the image is further performed based on the one or more cells in the image comprising the nucleus.
EC 11 is the method of any of ECs 1-10, wherein determining whether cells of the one or more cells comprise a nucleus comprises determining that a threshold between a foreground of the image and a background of the image exceeds a configurable difference.
EC 12 is the method of any of ECs 1-11, further comprising determining that pixel values of the image are indicative of a presence of DNA, and wherein determining whether cells of the one or more cells comprise a nucleus comprises determining that the pixel values indicative of the presence of DNA exceed a configurable threshold.
EC 13 is the method of any of ECs 1-12, further comprising calculating intensity of the pixel values in the image, which is proportional to a concentration of a fluorescent dye at a location of the pixel values, which is proportional to an amount of DNA at the location.
EC 14 is the method of any of ECs 1-13, further comprising determining a contour of the nucleus of the one or more cells.
EC 15 is the method of any of ECs 1-14, wherein categorizing, using the machine-learning logic executed on the processor, the one or more cells in the image is further performed based on the contour of the nucleus of the one or more cells satisfying a configurable threshold.
EC 16 is the method of any of ECs 1-15, wherein determining the contour of the nucleus of the one or more cells comprises determining one or more of an enclosing area, a perimeter, and a non-circularity of the image of the one or more cells.
EC 17 is the method of any of ECs 1-16, wherein determining the contour of the nucleus of the one or more cells comprises determining a radius of a circle enclosing and contacting the contour of the image of the one or more cells.
EC 18 is the method of any of ECs 1-17, wherein determining the contour of the nucleus of the one or more cells comprises determining a convexity of the contour of the nucleus of the image of the one or more cells.
EC 19 is the method of any of ECs 1-18, further comprising in response to determining that the cell of the one or more cells in the image comprises the nucleus, determining an area of the nucleus and dividing the area of the nucleus into adjacent geometrically distinct regions of the image of the one or more cells.
EC 20 is the method of any of ECs 1-19, further comprising determining a number of chromatin in the adjacent geometrically distinct regions; and categorizing, using the machine-learning logic executed on the processor, the one or more cells in the image when the number of chromatin in the adjacent geometrically distinct regions satisfy a configurable threshold.
EC 21 is the method of any of ECs 1-20, further comprising determining a density of chromatin in the adjacent geometrically distinct regions; and categorizing, using the machine-learning logic executed on the processor, the one or more cells in the image when the density of chromatin in the adjacent geometrically distinct regions satisfy a configurable threshold.
EC 22 is the method of any of ECs 1-21, further comprising determining a pixel intensity in the adjacent geometrically distinct regions; and categorizing, using the machine-learning logic executed on the processor, the one or more cells in the image when the pixel intensity in the adjacent geometrically distinct regions satisfy a configurable threshold.
EC 23 is a computing device comprising one or more processors, and non-transitory computer readable medium having stored therein instructions that when executed by the one or more processors, causes the computing device to perform functions comprising: identifying, using machine-learning logic, one or more cells in an image from a digital microscopy system, wherein the machine-learning logic is trained using cell image training data including digital microscopy images labeled with cell features; dividing an area of the image including the one or more cells into distinct regions to generate measurements of pixel value changes between the distinct regions; determining a presence and a location of RNA within the one or more cells in the image based on the measurements of pixel value changes; and categorizing, using the machine-learning logic, the one or more cells in the image when the presence and the location of the RNA is determined within the image of the one or more cells.
EC 24 is the computing device of EC 23, wherein dividing the area of the image including the one or more cells into distinct regions comprises dividing the image of the one or more cells into a plurality of annuli and determining the presence and the location of the RNA within the plurality of annuli, and the functions further comprise: determining a number of RNA in an outermost annulus of the plurality of annuli and determining a number of RNA in an innermost annulus of the plurality of annuli; and based on the number of RNA in the outermost annulus of the plurality of annuli and the number of RNA in the innermost annulus of the plurality of annuli, identifying a cell type.
EC 25 is the computing device of any of ECs 23-24, wherein the functions further comprise: in response to determining that the cell of the one or more cells in the image comprises a nucleus, determining an area of the nucleus and dividing the area of the nucleus into adjacent geometrically distinct regions of the image of the one or more cells; determining a number of chromatin in the adjacent geometrically distinct regions; and categorizing, using the machine-learning logic executed on the processor, the one or more cells in the image when the number of chromatin in the adjacent geometrically distinct regions satisfy a configurable threshold.
EC 26 is a non-transitory computer readable medium having stored thereon instructions, that when executed by one or more processors of a computing device, cause the computing device to perform functions comprising: identifying, using machine-learning logic, one or more cells in an image from a digital microscopy system, wherein the machine-learning logic is trained using cell image training data including digital microscopy images labeled with cell features; dividing an area of the image including the one or more cells into distinct regions to generate measurements of pixel value changes between the distinct regions; determining a presence and a location of RNA within the one or more cells in the image based on the measurements of pixel value changes; and categorizing, using the machine-learning logic, the one or more cells in the image when the presence and the location of the RNA is determined within the image of the one or more cells.
EC 27 is the non-transitory computer readable medium of EC 26, wherein dividing the area of the image including the one or more cells into distinct regions comprises dividing the image of the one or more cells into a plurality of annuli and determining the presence and the location of the RNA within the plurality of annuli, and the functions further comprise: determining a number of RNA in an outermost annulus of the plurality of annuli and determining a number of RNA in an innermost annulus of the plurality of annuli; and based on the number of RNA in the outermost annulus of the plurality of annuli and the number of RNA in the innermost annulus of the plurality of annuli, identifying a cell type.
EC 28 is the non-transitory computer readable medium of any of ECs 26-27, wherein the functions further comprise: in response to determining that the cell of the one or more cells in the image comprises a nucleus, determining an area of the nucleus and dividing the area of the nucleus into adjacent geometrically distinct regions of the image of the one or more cells; determining a number of chromatin in the adjacent geometrically distinct regions; and categorizing, using the machine-learning logic executed on the processor, the one or more cells in the image when the number of chromatin in the adjacent geometrically distinct regions satisfy a configurable threshold.

By the term “substantially” and “about” used herein, it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. The terms “substantially” and “about” represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A method for characterizing cells, the method comprising:
identifying, using machine-learning logic executed on a processor, one or more cells in an image from a digital microscopy system, wherein the machine-learning logic is trained using cell image training data including digital microscopy images labeled with cell features;
dividing an area of the image including the one or more cells into distinct regions to generate measurements of pixel value changes between the distinct regions;
determining a presence and a location of RNA within the one or more cells in the image based on the measurements of pixel value changes; and
categorizing, using the machine-learning logic executed on the processor, the one or more cells in the image when the presence and the location of the RNA is determined within the image of the one or more cells.

2. The method of claim 1, wherein categorizing the one or more cells using the machine-learning logic comprises:
distinguishing between an age of the one or more cells.

3. The method of claim 1, wherein dividing the area of the image including the one or more cells into distinct regions comprises dividing the image of the one or more cells into a plurality of annuli and determining the presence and the location of the RNA within the plurality of annuli.

4. The method of claim 3, further comprising:
determining a number of RNA in an outermost annulus of the plurality of annuli and determining a number of RNA in an innermost annulus of the plurality of annuli; and
based on the number of RNA in the outermost annulus of the plurality of annuli and the number of RNA in the innermost annulus of the plurality of annuli, identifying a cell type.

5. The method of claim 1, wherein dividing the area of the image including the one or more cells into distinct regions comprises determining a radial distribution of RNA within the image of the one or more cells.

6. The method of claim 1, wherein dividing the area of the image including the one or more cells into distinct regions comprises:
dividing the image of the one or more cells into a plurality of annuli; and
calculating a change in pixel intensities from an innermost annulus of the plurality of annuli and an outermost annulus of the plurality of annuli.

7. The method of claim 1, wherein identifying, using the machine-learning logic executed on the processor, the one or more cells in the image from the digital microscopy system comprises:
using the machine-learning logic executed on the processor on grayscale images capturing fluorescent intensity of a stain that binds to DNA or RNA.

8. The method of claim 1, further comprising:
normalizing an intensity of the image.

9. The method of claim 1, further comprising:
determining whether a cell of the one or more cells in the image comprise a nucleus.

10. The method of claim 9, wherein categorizing, using the machine-learning logic executed on the processor, the one or more cells in the image is further performed based on the one or more cells in the image comprising the nucleus.

11. The method of claim 9, wherein determining whether cells of the one or more cells comprise a nucleus comprises determining that a threshold between a foreground of the image and a background of the image exceeds a configurable difference.

12. The method of claim 9, further comprising:
determining that pixel values of the image are indicative of a presence of DNA; and
wherein determining whether cells of the one or more cells comprise a nucleus comprises determining that the pixel values indicative of the presence of DNA exceed a configurable threshold.

13. The method of claim 12, further comprising:
calculating intensity of the pixel values in the image, which is proportional to a concentration of a fluorescent dye at a location of the pixel values, which is proportional to an amount of DNA at the location.

14. The method of claim 9, further comprising:
determining a contour of the nucleus of the one or more cells.

15. The method of claim 14, wherein categorizing, using the machine-learning logic executed on the processor, the one or more cells in the image is further performed based on the contour of the nucleus of the one or more cells satisfying a configurable threshold.

16. The method of claim 14, wherein determining the contour of the nucleus of the one or more cells comprises determining one or more of an enclosing area, a perimeter, and a non-circularity of the image of the one or more cells.

17. The method of claim 14, wherein determining the contour of the nucleus of the one or more cells comprises determining a radius of a circle enclosing and contacting the contour of the image of the one or more cells.

18. The method of claim 14, wherein determining the contour of the nucleus of the one or more cells comprises determining a convexity of the contour of the nucleus of the image of the one or more cells.

19. The method of claim 9, further comprising:
in response to determining that the cell of the one or more cells in the image comprises the nucleus, determining an area of the nucleus and dividing the area of the nucleus into adjacent geometrically distinct regions of the image of the one or more cells.

20. The method of claim 19, further comprising:
determining a number of chromatin in the adjacent geometrically distinct regions; and
categorizing, using the machine-learning logic executed on the processor, the one or more cells in the image when the number of chromatin in the adjacent geometrically distinct regions satisfy a configurable threshold.

21. The method of claim 19, further comprising:
determining a density of chromatin in the adjacent geometrically distinct regions; and
categorizing, using the machine-learning logic executed on the processor, the one or more cells in the image when the density of chromatin in the adjacent geometrically distinct regions satisfy a configurable threshold.

22. The method of claim 19, further comprising:
determining a pixel intensity in the adjacent geometrically distinct regions; and
categorizing, using the machine-learning logic executed on the processor, the one or more cells in the image when the pixel intensity in the adjacent geometrically distinct regions satisfy a configurable threshold.

23. A computing device comprising:
one or more processors; and
non-transitory computer readable medium having stored therein instructions that when executed by the one or more processors, causes the computing device to perform functions comprising:
identifying, using machine-learning logic, one or more cells in an image from a digital microscopy system, wherein the machine-learning logic is trained using cell image training data including digital microscopy images labeled with cell features;
dividing an area of the image including the one or more cells into distinct regions to generate measurements of pixel value changes between the distinct regions;
determining a presence and a location of RNA within the one or more cells in the image based on the measurements of pixel value changes; and
categorizing, using the machine-learning logic, the one or more cells in the image when the presence and the location of the RNA is determined within the image of the one or more cells.

24. The computing device of claim 23, wherein dividing the area of the image including the one or more cells into distinct regions comprises dividing the image of the one or more cells into a plurality of annuli and determining the presence and the location of the RNA within the plurality of annuli, and the functions further comprise:
determining a number of RNA in an outermost annulus of the plurality of annuli and determining a number of RNA in an innermost annulus of the plurality of annuli; and
based on the number of RNA in the outermost annulus of the plurality of annuli and the number of RNA in the innermost annulus of the plurality of annuli, identifying a cell type.

25. The computing device of claim 23, wherein the functions further comprise:
in response to determining that the cell of the one or more cells in the image comprises a nucleus, determining an area of the nucleus and dividing the area of the nucleus into adjacent geometrically distinct regions of the image of the one or more cells;
determining a number of chromatin in the adjacent geometrically distinct regions; and
categorizing, using the machine-learning logic executed on the processor, the one or more cells in the image when the number of chromatin in the adjacent geometrically distinct regions satisfy a configurable threshold.

26. A non-transitory computer readable medium having stored thereon instructions, that when executed by one or more processors of a computing device, cause the computing device to perform functions comprising:
identifying, using machine-learning logic, one or more cells in an image from a digital microscopy system, wherein the machine-learning logic is trained using cell image training data including digital microscopy images labeled with cell features;
dividing an area of the image including the one or more cells into distinct regions to generate measurements of pixel value changes between the distinct regions;
determining a presence and a location of RNA within the one or more cells in the image based on the measurements of pixel value changes; and
categorizing, using the machine-learning logic, the one or more cells in the image when the presence and the location of the RNA is determined within the image of the one or more cells.

27. The non-transitory computer readable medium of claim 26, wherein dividing the area of the image including the one or more cells into distinct regions comprises dividing the image of the one or more cells into a plurality of annuli and determining the presence and the location of the RNA within the plurality of annuli, and the functions further comprise:
determining a number of RNA in an outermost annulus of the plurality of annuli and determining a number of RNA in an innermost annulus of the plurality of annuli; and
based on the number of RNA in the outermost annulus of the plurality of annuli and the number of RNA in the innermost annulus of the plurality of annuli, identifying a cell type.

28. The non-transitory computer readable medium of claim 26, wherein the functions further comprise:
in response to determining that the cell of the one or more cells in the image comprises a nucleus, determining an area of the nucleus and dividing the area of the nucleus into adjacent geometrically distinct regions of the image of the one or more cells;
determining a number of chromatin in the adjacent geometrically distinct regions; and
categorizing, using the machine-learning logic executed on the processor, the one or more cells in the image when the number of chromatin in the adjacent geometrically distinct regions satisfy a configurable threshold.
